(19) United States
(12) Patent Application Publication
(10) Pub. No.: US 2011/0058996 A1
(43) Pub. Date: Mar. 10, 2011

(54) REFORMER FOR CONVERTING GASEOUS FUEL AND OXIDIZING AGENT INTO A REFORMATE

(75) Inventors: Stefan Kah, Neubrandenburg (DE); Johannes Eichstadt, Neubrandenburg (DE)

(73) Assignee: ENERDAY GMBH, Stockdorf (DE)

(21) Appl. No.: 12/377,451

(22) PCT Filed: Jul. 6, 2007
(86) PCT No.: PCT/DE2007/001204

§ 371 Date: Jun. 24, 2010

(30) Foreign Application Priority Data
Aug. 25, 2006 (DE) 10 2006 039 933.1

(51) Int. Cl. B01J 8/04; B01J 8/02

(52) U.S. Cl. 422/625; 422/211

(57) ABSTRACT

The invention relates to a reformer for reacting fuel and oxidant into reformate, comprising a reforming zone (12) which can receive a supply of fuel, and from an upstream oxidation zone, a mixture of oxidant and at least partially oxidized fuel for catalytic reaction into the reformate.

To boost the reforming efficiency it is proposed that the reforming zone (12) now comprises a first (32) and second (48) catalytic reaction zone in the streaming direction of the gas flow, each arranged separately from the other and interposed by a non-catalytic active homogenization zone (44) for homogenizing gas components emerging from the first reaction zone (32).

The configuration in accordance with the invention now achieves that after first partial reforming the gas is homogenized to achieve a more efficient second partial reforming.

The present invention relates to a reformer for reacting gaseous fuel and oxidant into reformate, comprising a reforming zone which receives a supply of fuel and from an upstream oxidation zone, a mixture of oxidant and at least partially oxidized fuel for catalytic reaction into the reformate.

The invention relates furthermore to a reformer for reacting fuel and oxidant into reformate, comprising a reforming zone which receives a supply of fuel and from an upstream oxidation zone, a mixture of oxidant and at least partially oxidized fuel for catalytic reaction into the reformate, the fuel and the mixture being feedable via a common feeder upstream of the reforming zone.

German patent DE 103 95 205 A1 discloses a reformer as it reads from the preamble of claim 1.

Generic reformers have a wealth of different applications, they serving in particular to feed a fuel cell with a gas mixture rich in hydrogen from which electrical energy can be generated on the basis of electrochemical reactions. Such fuel cells find application, for example, in coupling power and heat and in automotive engineering as auxiliary power units (APUs).

In the reformer, fuel, particularly in the form of hydrocarbonate gas or produced as such from liquid or solid starting material is broken down in an endothermic reaction in the scope of partial catalytic oxidation, especially with the intention to obtain hydrogen and carbon monoxide termed together as synthesis gas. In making available the heat needed for the endothermic reaction it is known particularly to utilize energy from an upstream exothermic oxidation of fuel from an upstream oxidation zone in which fuel is oxidized at least in part with an oxidant. Hot combustion exhaust gas still containing unconsumed oxidant, e.g. oxygen is fed together with fresh fuel to the reforming zone where the synthesis gas is generated catalytically.

The drawback with this known reformer is that the synthesis gas fails to be completely reacted, particularly when using compact reformers and although the reaction can be rendered more efficient by using larger reforming zones, this bigger size is undesirable especially in automotive engineering.

Known from German patent DE 102 30 149 A1 is a reformer whose reforming zone is packed with a porous material, the inner surfaces of which enhance a catalytic reaction whilst reducing the rate at which the gas streams through the reforming zone. Although this can achieve more efficient reforming, there is still a need for improvement.

Known from German patent D 199 47 312 A1 is a reformer in accordance with the preamble of claim 6 wherein the fuel and the combustion exhaust gas from the oxidation zone, in other words, the fuel oxidant mixture, are first mixed in a feeder upstream of the reforming zone and then injected in common into the reforming zone. This achieves a more homogenized mixture of the gas to be reformed, resulting in enhanced reforming efficiency.

The drawback with this known feeder is, however, the complex engineering of the injection device necessitating complicated mechanical and electronic features for control which adds to the cost unwantedly.

The invention is based on the object of making available a reformer for reacting fuel and oxidant into reformate which sidesteps the cited problems, at least in part, and which now achieves a boost in efficiency particularly in avoiding the drawbacks of added size and costs.

This object is achieved by the features as recited in the independent claims.

Advantageous embodiments of the invention read from the dependent claims.

The invention is a sophistication of a reformer as set forth in the preamble of claim 1 in that the reforming zone now comprises a first and second catalytic reaction zone in the streaming direction of the gas flow, each arranged separately from the other and interposed by a non-catalytic active homogenization zone for homogenizing gas components emerging from the first reaction zone.

The invention is based on having discovered that lack of efficiency in reforming is due, at least in part, to lack of homogenization of the gases in the reforming zone. This can happen, even with very good homogenization of the output mixtures introduced into the reforming zone, because the reforming process in the reforming zone itself advances spatially uneven, resulting in lack of homogeneity within the reforming zone. This is why it is now provided for in accordance with the invention to schedule reforming at least in part firstly in a first reaction zone and to then homogenize the resulting gas components, i.e. input the synthesis gas and fuel still to be reformed as well as the fuel/oxidant mixture by feeding this homogenized gas mixture to a second reaction zone for final reforming.

It is provided for to advantage that at least one of the reaction zones, but preferably both, are packed with a catalytic active monolith. The advantages of configuring a reaction zone in the reforming zone as a catalytic activated monolith are known from prior art, this particularly involving upsizing the catalytic active surface in the reaction zone. By interposing a zone having no porous media in an arrangement of two porous media in sequence in the streaming direction of the gas flow the present invention is achievable particularly favorably because it is quite natural that totally different flow conditions exist in the porous media and in the interposed homogenization zone, resulting in an efficient intermixing of the gas components materializing in the first reaction zone of the homogenization zone.

To further boost efficiency it is provided for to advantage that the inner surfaces of the porous medium/media are now coated with catalytic active material promoting the wanted conversion of the output gases in generating the synthesis gas.

As aforementioned, the homogenization zone having no porous media serves to thoroughly mix the gas components emerging from the first reaction zone. Unlike homogenization, intermixing is now supported by the greater diffusion coefficients of the synthesis gas components, i.e. hydrogen and carbon monoxide, as compared to hydrocarbonate fuel, before introduction into the first reaction zone. To further improve intermixing in the homogenization zone it is provided for in one advantageous aspect of the invention that the homogenization zone now comprises one or more gas baffles to create added turbulence, for which basically any gas baffle is suitable as known from flow technology for creating turbulence.

It has been discovered to be of particularly advantage when an annular orifice is provided as the gas baffle, because, for one thing, an annular orifice is simple and cheap to engineer, for another, the annular orifice in addition to enhancing intermixing accelerates the gas flow to thus improve introduction of the flow into the second reaction zone.

The invention is also a sophistication of the reformer as it reads from the preamble of claim 6 in that the feeder is configured as a ring-shaped mixing chamber, the output end of which is coupled to the reforming zone, the mixing chamber being supplied with fuel or mixture via ports at its input end and with a mixture or fuel via ports in its shell surface.

This special configuration of the common feeder for fuel and fuel/oxidant mixture is particularly simple to engineer and thus especially of advantage as regards the costs and also the size involved. Particularly in embodiments in which the reforming zone is streamed with a reverse flow of hot combustion exhaust gas, introducing the mixture via ports in the shell surface of the mixing chamber is of advantage since this permits the input of fresh fuel via ports at the input end. Intermixing in the mixing zone is particularly effective due to two streams of gas are now combined substantially vertically as a result of the gas flow introduced via the ports at the input end being substantially axially oriented whilst the gas flow introduced via the ports in the shell surface is substantially oriented radially inwards. This ring-shaped configuration of the mixing zone also ensures that any azimuthal mixing zone portion ends up in being relatively small for the good of an efficient mixture. Configuring the mixing zone simply tubular could result in a strong concentration gradient materializing in portions of the mixing zone near to and far from the axis.

It is favorably provided for that the bore of the mixing chamber is reduced from the input end to the output end. In other words, the mixing zone may be configured as a ring nozzle, increasing the rate at which the gas flows to the output of the mixing zone in further enhancing the intermixing efficiency whilst ensuring a better feed into the reforming zone.

Since there is always the risk of spontaneous ignition in the mixing chamber when mixing fresh fuel with oxidant to produce an ignitable gas, resulting in sooting up of the system, it is provided for to advantage that the mixing chamber is now very small in size and thus the gas components are resident therein just for a few milliseconds, reflecting the reaction times as are typical for the oxidation reactions as relevant in this case. Simply by equating laws governing the physics thereof the person skilled in the art is able to tweak the length of the mixing chamber in accordance with the rates at which the gas streams through.

Preferably, the aspect of the invention as last described, relating to a ring-shaped mixing chamber is combined with the aspect as described previously as to a homogenization zone employed as a reforming zone divided into two reaction zones. It is understood that all embodiments and aspects as described may be combined to ensure an added increase in efficiency by achieving the cited object particularly favorably.

The invention will now be detailed by way of preferred embodiments with reference to the attached drawings in which:

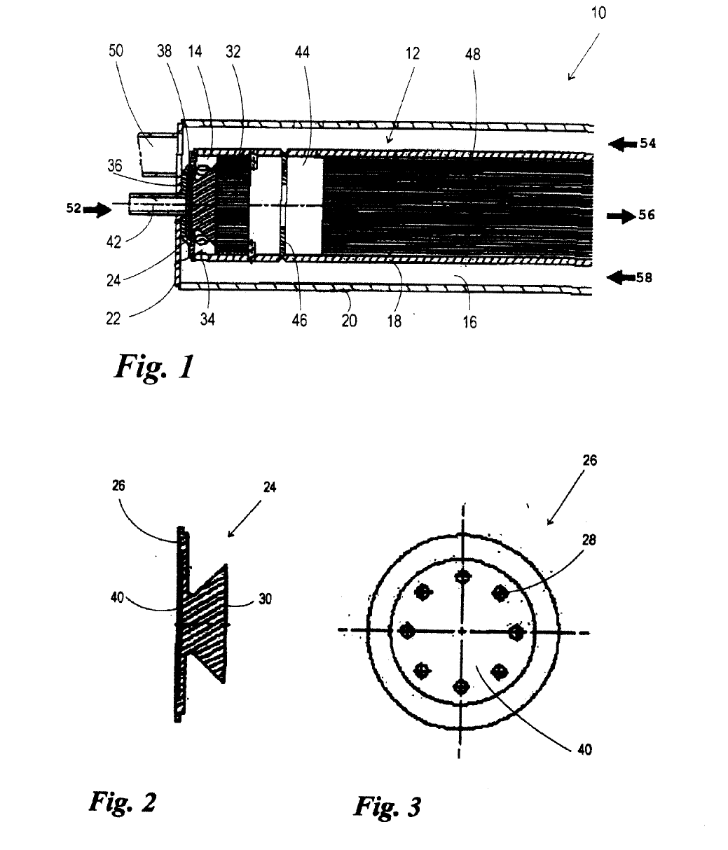

FIG. 1 is a section view taken along the longitudinal centerline of the reformer system in accordance with the invention;

FIG. 2 is a section view on a magnified scale taken through a mixing chamber central body of the reformer in the system as shown in FIG. 1, and

FIG. 3 is a top-down view of the mixing chamber central body as shown in FIG. 2.

Referring now to FIG. 1 there is illustrated a section view through a reformer system 10 in accordance with the invention. The reformer system 10 comprises the actual reformer 12, an upstream mixing chamber 14 enclosed by a combustion exhaust gas conduit 16. In the embodiment as shown the reformer 12 and its upstream mixing chamber 14 are configured substantially cylindrical, one assembly enclosed by a first cylindrical shell 18 comprising the reformer 12 and the upstream mixing chamber 14. The first cylindrical shell 18 is arranged coaxially in a second cylindrical shell 20 of larger diameter. The combustion exhaust gas conduit between the shells 18 and 20 is connected to the outlet of a oxidation zone (not shown) in conducting the stream of combustion exhaust gas from the oxidation zone. Enveloping the reformer 12 in a stream of hot combustion exhaust gas results in heat being exchanged between the combustion exhaust gas and reformer 12 so that the thermal energy of the combustion exhaust gas can be made use of to support endothermic catalytic reforming.

In the vicinity of the end closure 22 connecting the combustion exhaust gas conduit substantially gas-tight is the mixing chamber 14 which in the embodiment as shown comprises a portion of the first cylindrical shell 18 and a mixing chamber central body 24 (shown in detail in FIG. 2). The mixing chamber central body 24 comprises a closure plate 26 serving as the input end in closing off the first cylindrical shell 18 and forming the input end of the mixing chamber 14. As evident in FIG. 3 the closure plate 26 comprises in an internal portion ports 28 which in the embodiment as shown are configured as drilled holes whereas in other embodiments these may be configured, for example, as slots. Adjoining the closure plate 26 is a conical body in the shape of truncated cone or tubular truncated cone, the base of which forms the internal portion of the output end of the mixing chamber 14 coupled to the input surface of a first reaction zone 32 of the reformer 12. The diameter of the base conical body 30 is smaller than the diameter of the first cylindrical shell 18 and thus smaller than the diameter of the mixing chamber 14. Thus, closure plate 26, reformer system 10 and first cylindrical shell 18 form a ring-shaped mixing chamber 14 having a bore tapered towards its output. In the region of the conical body 30 the first cylindrical shell 18 comprises one or more ports 34 via which the mixing chamber 14 is in gas exchanging contact with the combustion exhaust gas conduit. This gas exchange is possible only in the direction of the evaporator chamber.

The inner portion of the closure plate 26 featuring the ports 28 is sealed off gas-tight from the combustion exhaust gas conduit by a cover element 36 so that a short gas distribution chamber 38 materializes upstream of the closure plate 26, the volume of which in the embodiment as shown is enlarged by a circular recess 40 in the inner portion of the closure plate 26. In this arrangement the ports 28 are located in the region of the circular recess 40 but outside of the conical body 30.

The cover element 38 is connected gas-tight to a fuel feeder conduit 42 via which gaseous fresh fuel can be fed into the gas distribution chamber 38 and then through ports 28 into the mixing chamber 40. In operation combustion exhaust gas is introduced via the ports 34 into the mixing chamber 14 where it is admixed with the fresh fuel. The reduction in the bore produced by the conical body 30 results in the stream of gas being accelerated through the mixing chamber 14 into the first reforming zone of the reformer 12, it being here that the gas components supplied to the mixing chamber 14 are converted at least in part into synthesis gas. To boost the efficiency of this conversion, the first reaction zone 32 in the embodiment as shown is packed with a porous medium, the inner surfaces of which are coated with catalytic material at which generation of the synthesis gas occurs. Provided downstream of the first reaction zone 32 is a homogenization zone 44. This is substantially a space which in particular is not packed with a porous medium, it being here that all gas components emerging from the first reaction zone 32 are intermixed. Homogenization of the resulting gas is further improved by the arrangement of a coaxially positioned annular orifice 46 in the homogenization zone 44 whose task it is to achieve a turbulent vortex and acceleration of the gas flow in the direction of a second reaction zone 48 following the homogenization zone 44. It is in the second reaction zone 48 which in the embodiment as shown is likewise packed with a porous medium having a catalytic surface coating that the concluding conversion of the gas components into the wanted synthesis gas occurs. In the embodiment as shown, the second reaction zone 48 extends over a portion which is longer axially than that of the first reaction zone 32.

Not shown in FIG. 1 is the output of the second reaction zone 48, to which, in advantageous embodiments of the invention, discharge conduits are connected to draw off the resulting synthesis gas, particularly or feeding the synthesis gas to a downstream fuel cell.

It will, of course, be appreciated that the embodiments as discussed in the special description and as shown in the drawings are merely illustrative example aspects of the present invention, from which the person skilled in the art can read a wealth of different possible variations all in the scope of the teaching as disclosed presently. More particularly he will be required to adapt the absolute and relative dimensions of the various elements of the invention and their choice of material to the particular requirements of the concrete application. In selecting the fuel too, the person skilled in the art can make recourse to a host of variants including, for example, natural gas, liquified gas, methane, etc. And, of course, the person skilled in the art can provide one or more ports for installing sensing elements, such as for example lambda sensors or temperature sensing elements. In the embodiment as shown in FIG. 1 one such port is provided in the end closure 22 and identified by reference numeral 50.

It is understood that the features of the invention as disclosed in the above description, in the drawings and as claimed may be essential to achieving the invention both by themselves or in any combination.

### LIST OF REFERENCE NUMERALS

10 reformer system
12 reformer
14 mixing chamber
16 combustion exhaust gas conduit
18 first cylindrical shell
20 second cylindrical shell
22 closure plate of 20
24 mixing chamber central body
26 closure plate of 24
28 drilled hole in 26
30 conical body of 24
32 first reaction zone of 12
34 port in 18
36 cover element
38 gas distribution chamber
40 recess in 26
42 fuel feeder conduit
44 homogenization zone
46 annular orifice
48 second reforming zone
50 lambda sensor mount
52 combustion gas
54 combustion exhaust gas

1. A reformer for reacting fuel and oxidant into reformate, comprising a reforming zone which can receive a supply of fuel and, from an upstream oxidation zone, a mixture of oxidant and at least partially oxidized fuel for catalytic reaction into the reformate, characterized in that the reforming zone comprises a first and second catalytic reaction zone in the streaming direction of the gas flow, each arranged separately from the other and interposed by a non-catalytic active homogenization zone for homogenizing gas components emerging from the first reaction zone.

2. The reformer of claim 1, wherein at least one of the reaction zones is largely packed with a porous medium.

3. The reformer of claim 2, wherein the inner surface of the porous medium is coated with catalytic active material.

4. The reformer of claim 1, wherein the homogenization zone comprises one or more gas baffles to create turbulences.

5. The reformer of claim 4, wherein an annular orifice is provided as the gas baffle.

6. A reformer for reacting fuel and oxidant into reformate, comprising:
a reforming zone which can receive a supply of fuel and, from an upstream oxidation zone,
a mixture of oxidant, and
at least partially oxidized fuel for catalytic reaction into the reformate, the fuel and the mixture being feedable via a common feeder upstream of the reforming zone, wherein the feeder is configured as a ring-shaped mixing chamber, the output end of which is coupled to the reforming zone, the mixing chamber can be supplied with fuel or mixture via ports at its input end and with mixture or fuel via ports in its shell surface.

7. The reformer of claim 6, wherein the bore of the mixing chamber is reduced from the in-put end to the output end.

8. The reformer of claim 6, wherein the length of the mixing chamber is adapted to the rate of flow of the gases so that the gas components are resident in the mixing chamber just for a few milliseconds on an average.

9. The reformer as of claim 6, wherein the reforming zone comprises a first and second catalytic reaction zone in the streaming direction of the gas flow, each arranged separately from the other and interposed by a non-catalytic active homogenization zone for homogenizing gas components emerging from the first reaction zone.

10. The reformer of claim 9, wherein at least one of the reaction zones is largely packed with a porous medium.

11. The reformer of claim 10, wherein the inner surface of the porous medium is coated with a catalytic active material.

12. The reformer of claim 9, wherein the homogenization zone comprises one or more gas baffles to create turbulences.

13. The reformer of claim 12, wherein an annular orifice is provided as the gas baffle.
